(19) United States
(12) Patent Application Publication
(10) Pub. No.: US 2011/0269610 A1
(43) Pub. Date: Nov. 3, 2011

(54) System and Method for Assembly of Packettes Having Closures

(75) Inventors: David Moreau, Fayetteville, NY (US); Thomas Larkin, Marathon, NY (US)

(73) Assignee: MARIETTA CORPORATION, Cortland, NY (US)

(21) Appl. No.: 13/114,600

(22) Filed: May 24, 2011

Related U.S. Application Data
(63) Continuation-in-part of application No. 12/768,786, filed on Apr. 28, 2010.

(51) Int. Cl. B31B 1/90

(52) U.S. Cl. 493/214

(57) ABSTRACT

A method of automatically manufacturing a filled packette having a closure where a film is advanced from a feed roller to a punch that produces a series of holes in the film. Individual closures are then positioned into each punched hole and ultrasonically welded into place. The film is folded and oriented vertically so that heat sealing may be used to form the side and bottom edges of individual pockets. The film is then clipped to form individual pockets and filed with the appropriate amount of desired material from a bulk feeder. The filled pockets may be sealed along the top edge to form a closed packette and die cut to form the final packette shape.

### CROSS-REFERENCE TO RELATED APPLICATIONS

The present application is a continuation-in-part of U.S. patent application Ser. No. 12/768,786, filed on Apr. 28, 2010.

### BACKGROUND OF THE INVENTION

1. Field of the Invention

The present invention relates to systems and methods for forming packaging and, more particularly, to a system and method for automatically manufacturing packettes having individual resealable closures.

2. Description of the Related Art

The conventional method for forming and filling packettes having closures involves hand loading, orienting, and manually filling and sealing individual packettes. While horizontal conventional feed filling machines are able to automatically fill and seal pre-formed pouches or pockets, there is no known method or system for automatically creating forming packettes having individual closures or, more specifically, forming such packettes as part of the filling and sealing process. Instead, conventional systems require the separate manual formation of the packets apart from the filling and sealing process. Additionally, convention feed systems route the film material through rollers and sharp angles that will tear any inflexible attachments off of the film due to the inability of the attachments to turn in the same radius as the film. As a result, such systems are prone to human error, very labor intensive, and more expensive than a fully automated system, and incapable of handling attachments to the film.

### BRIEF SUMMARY OF THE INVENTION

It is therefore a principal object and advantage of the present invention to provide a system and method for automatically creating and filling packettes having closures.

It is an additional object and advantage of the present invention to provide a system and method for creating and filling packettes having closures that improves the ease of inspection.

It is an additional object and advantage of the present invention to provide a system and method for creating and filling packettes having closures that improves the quality of the finished packette.

In accordance with the foregoing objects and advantages, the present invention provides an automated system for manufacturing packettes having closures and filling the packettes with bulk materials. First, the desired film for forming the packette is loaded onto a feed roller and advanced horizontally before a punch. As the film is advanced, the punch forms holes in the film dimensioned to correspond to the closure. Individual closures are then positioned into each punched hole and ultrasonically welded into place. The film containing the welded closures is then folded and oriented vertically and then heat sealed to define the side and bottom edges of each individual pocket that will include one of the welded closures. The film is then clipped to form individual pockets and filed with the appropriate amount of desired material from a bulk feeder. The filled pockets may be sealed along the top edge to form a closed packette and die cut, if required, to form the final packette shape. Automated or manual inspection stations may be positioned at critical locations in the process, such as after the welding of the closure to the film.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a top view schematic of a manufacturing process according to the present invention.

FIG. 2 is a side view schematic of a manufacturing process according to the present invention.

FIG. 3 is a perspective view of a packette according to the present invention.

FIG. 4 is a top view of a guide according to the present invention.

FIG. 5 is a side view of a guide according to the present invention.

FIG. 6 is an end view of a guide according to the present invention as seen from the downstream side.

### DETAILED DESCRIPTION OF THE INVENTION

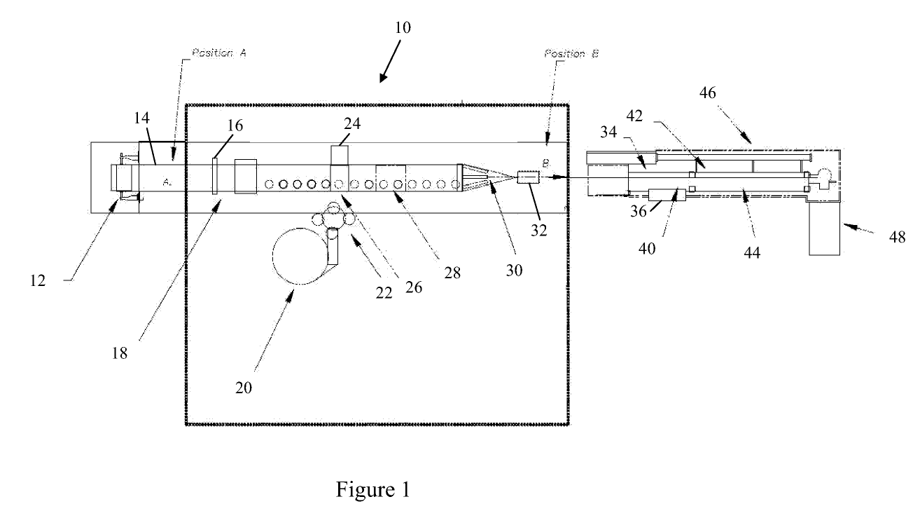

Referring now to the drawings, wherein like reference numerals refer to like parts throughout, there is seen in FIG. 1 a system 10 according to the present invention for automatically manufacturing and filling packettes with bulk materials. System 10 comprises feed roll 12 for supplying a film 14 of a packette substrate in a horizontal direction (Position A). Packette substrate may comprise various plastics, laminates and other know packaging materials. System 10 further includes a pair of rollers 16 or support guides for advancing film 14 from feed roll 12. A hole punch 18 is positioned downstream of rollers 16 and adapted to punch a series of holes in film 14 as it is advanced along.

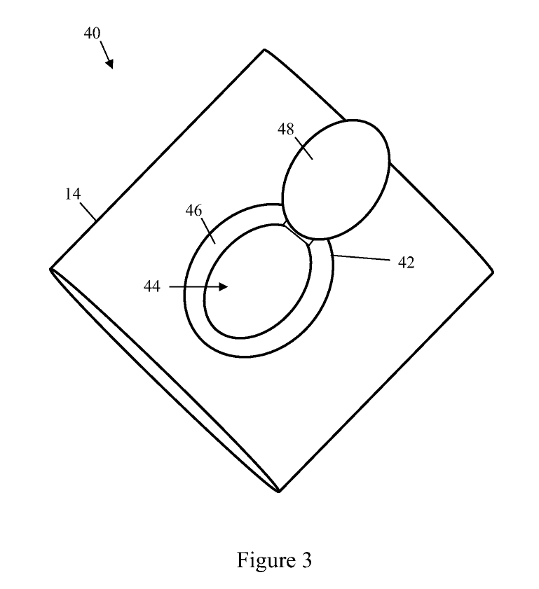

System 10 further comprises a feeder bowl 20 positioned downstream of punch 18 and including a pick and place device 22 for positioning a packette closure, such as a resealable closure 40 shown in FIG. 3, in each hole that is punched in film 14. Feeder bowl 20 further includes an ultrasonic welder 24 for attaching the closures when positioned in an associated weld nest 26 located inline or downstream from the location of the placement of the closure on film 14. If welder 24 is located downstream, a mechanism for temporarily holding the closure to the film while it travels to the weld station may be used, such as a vacuum, belt, linear conveyor or the like. Welder 24 preferably comprises a 20,000 Hz ultrasonic welder, such as a Model 910W available from Branson Ultrasonics Corp. of Danbury, Conn. An inspection station 28 may be located downstream of weld nest 26 for automatic or manual verification that the closures have been properly located and welded to film 14.

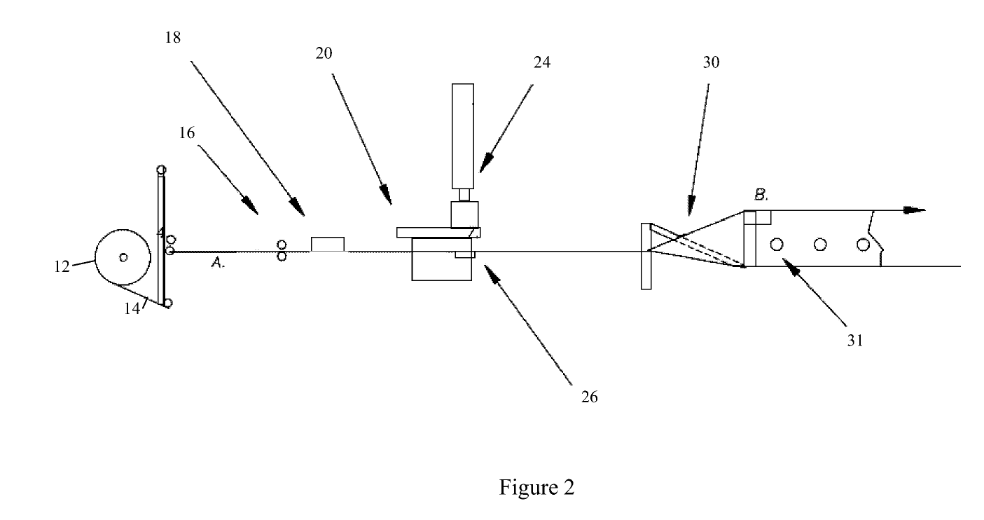

System 10 further comprises adjustable guide rods 30 or a formed sheet of metal or smooth material positioned downstream of inspection station 28 for folding film 14 and reorienting film 14 vertically for filling and sealing operations. Guides 30 are preferably of sufficient length, angle, and initial starting height to evenly transition film 14 from a horizontal orientation to a vertical orientation (Position B). Referring to FIG. 2, film 14 comprises a series of closures 31 welded along a given length of film 14 at this point. Drive rollers 32 may be positioned proximately to guides 30 for further advancing film 14.

System 10 additionally comprises seal bars 34 are also positioned downstream of guides 30 to form a pocket in film 14 by seal forming side and bottom edges around each closure welded to film 14. Cutting knives 36 are then positioned to cut film 14 to form individual pockets in film 14, each of which is associated with a welded closure. Cut pockets may be advanced by a clipped chain 38 and located before a second inspection station 40, to automatically or manually ensure that the closure is properly in place prior to filling.

A filling station 42 is positioned downstream of clipped chain 38 for filing each pocket with whatever bulk supplies are desired. Another visual inspection station 44 may be positioned after filling station 42. Preferably, inspection station 44 employs a vision camera for automatically checking the filled pocket to verify that it has been properly formed and filled. A Model 3G7 or 3G1 vision sensor system available from Cognex of Natick, Mass.

Finally, a sealing device 46 for sealing the top of the pockets is used to form a sealed packette. A die cutter 48 is positioned downstream from sealing device 46 to cut the packettes into the final, desired shape. Completed packets may be collected or dropped onto an offload conveyor for transportation elsewhere, such as to a location for packing multiple packets for shipment to consumers.

It should be recognized by those of skill in the art that a conventional horizontal pouch packaging machine, such as a Bartelt® IM Fill and Seal Machine may be adapted for transferring the formed pockets once the film is oriented horizontally by guides 30, placing the pockets within the leading and trailing clamps of chain 38, and opening, filling and sealing the pockets to form the closured packettes.

As seen in FIG. 3, finished packette 40 includes a closure 42 welded to one major side surface thereof for selectively permitting access to an internal cavity 44 of packette 40. Closure 42 preferably comprises a body 46 that provides a point of adherence to film 14 and a cover 48 pivotally mounted to body 48 for movement between a open position, where cover 46 allows communication with cavity 44, and a closed position, where cover 46 prohibits communication with cavity 44.

The method of the present invention involves loading a desired film onto a feed roller and advancing the film horizontally before a punch. As the film is advanced, the punch produces a series of holes in the film that are dimensioned to correspond to the packette closure device to be used. Individual closures are then positioned into each punched hole and ultrasonically welded into place by fusing the closure to the film. After optional inspection, the film is folded and oriented vertically so that heat sealing may be used to form the side and bottom edges of individual pockets around each welded closure. The film is then clipped to form individual pockets, optionally inspected and filed with the appropriate amount of desired material from a bulk feeder. After another optional inspection step, the filled pockets may be sealed along the top edge to form a closed packette, die cut to form the final packette shape, and offloaded onto a conveyor for further handling and shipment.

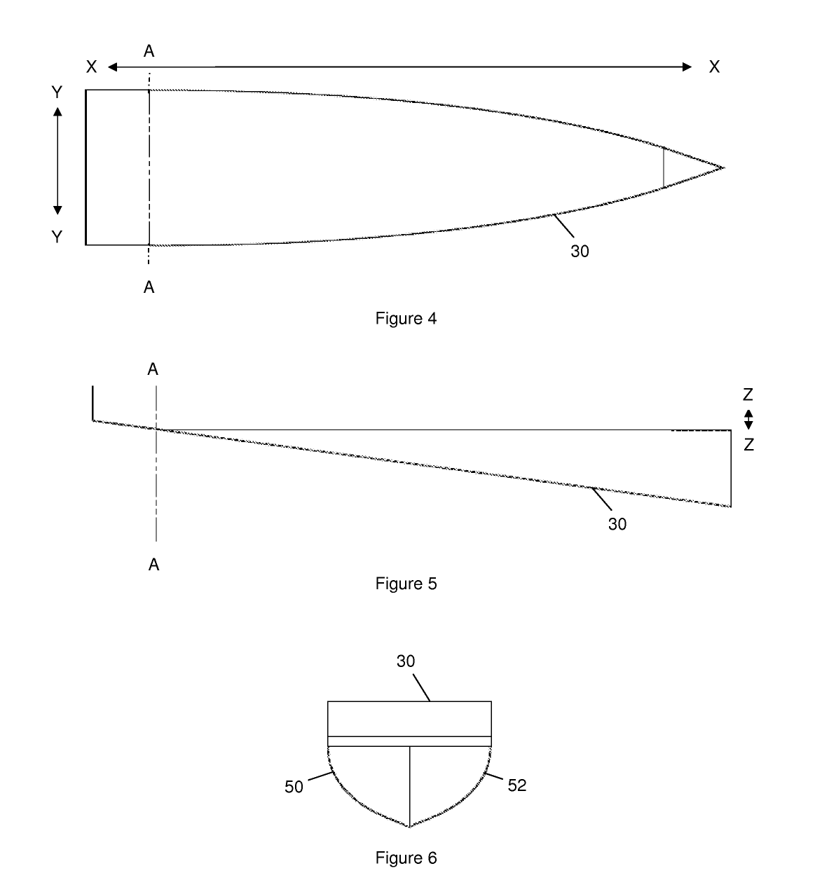

There is seen in FIGS. 4-6 a preferred embodiment of guide 30 for reorienting film 14 from a horizontal position, where closure 40 was attached, to a vertical position for filling and sealing operations. Guide 30 comprises a formed sheet of metal or smooth material that gradually transitions at line A-A from a horizontal orientation to a vertical orientation over its length. In general, guide 30 comprises a drop down step to lower film 14, a smooth face compound curve plow with no sharp angles that will catch closure 40 and maintain steady film travel during the transition, and adjustability to ensure registration of film 14. The curved surface of guide 30 provides a continuous surface contact on film 14 through both the horizontal and vertical positions to help alignment of film 14. As seen in FIG. 6, guide may be configured to reorient film 14 while, at the same time, folding film 14 in half by having to opposing surfaces 50 and 52 that correspondingly reorient one half of film 14 from a horizontal orientation in one direction while reorienting the other half of film 14 in the opposing direction

As an example, guide 30 may have an overall length X-X of about thirty-seven inches, a width Y-Y of about nine inches, and descent Z-Z of about five feet. Those of skill in the art will recognize that the absolute distances may vary depending on the particular upstream and downstream equipment, while keeping the relative proportions substantially constant. Those of skill in the art will also recognize that the value may be modified depending on the physical properties of closure 40 and, in particular, how the physical properties affect how quickly that closure 40 can be transitioned from a vertical orientation to a horizontal orientation without adverse consequences.

The particular design of guide 30 makes it possible to pull film 14 with an attached fitment, such as closure 40 through a horizontal form fill machine, such as a Bartlett machine. Without guide 30, the attachments would rip out of film 14 as film 14 moved through the conventional plow of a horizontal form fill machine as any sharp angle made by film 14 would normally detach the film from closure 40 by pulling the sealed material from the closure 40 because closure 40 cannot bend a corner as readily as film 14. Guide 30 having the described plow design thus allows for marriage of upstream operations requiring fixed attachments to conventional horizontal form fill and seal systems.

What is claimed is:

1. An apparatus for forming a packette, comprising:
a feed roll for supplying a substrate in a horizontal orientation;
means for positioning a closure on said substrate;
a guide for reorienting said substrate and said closure from the horizontal orientation to a vertical orientation;
means for forming a packette from said substrate and said closure while said substrate is in the vertical orientation.

2. The apparatus of claim 1, wherein said guide comprises a continuous sheet that transitions said substrate from a horizontal orientation proximate to said means for positioning a closure to a vertical orientation proximate to said means for forming a packette.

3. The apparatus of claim 2, wherein said continuous sheet descends vertically from said means for positioning a closure to said means for forming a packette.

4. The apparatus of claim 3, wherein said continuous sheet includes a compound curve.

5. The apparatus of claim 4, wherein said continuous sheet gradually folds into two opposing sides so that said substrate is folded in half when transitioned from the horizontal orientation to the vertical orientation.

6. The apparatus of claim 5, wherein said means for forming a packette from said substrate and said closure comprises a vertical form fill and seal machine.

7. A method of forming a packette, comprising the steps of:
horizontally advancing a film of substrate;
attaching a closure to said substrate;
reorienting said substrate vertically using a guide;
vertically advancing said substrate while forming and filling packettes in said substrate.

8. The method of claim 7, wherein said guide comprises a continuous sheet that transitions said substrate from a horizontal orientation proximate to said means for positioning a closure to a vertical orientation proximate to said means for forming a packette.

9. The apparatus of claim 8, wherein said continuous sheet descends from said means for positioning a closure to said means for forming a packette.

10. The apparatus of claim 9, wherein said continuous sheet includes a compound curve.

11. The apparatus of claim 10, wherein said continuous sheet gradually folds into two opposing sides so that said substrate is folded in half as it transitions from the horizontal orientation to the vertical orientation.
